(19) United States
(12) Patent Application Publication
(10) Pub. No.: US 2017/0356929 A1
(43) Pub. Date: Dec. 14, 2017

(54) Z-AXIS STRUCTURE OF ACCELEROMETER AND MANUFACTURING METHOD OF Z-AXIS STRUCTURE

(71) Applicant: Goertek, Inc., Weifang City, Shandong (CN)

(72) Inventor: Guoguang ZHENG, Weifang City (CN)

(21) Appl. No.: 15/546,824

(22) PCT Filed: Jul. 23, 2015
(86) PCT No.: PCT/CN2015/084966

§ 371 Date: Jul. 27, 2017

(30) Foreign Application Priority Data
Jan. 30, 2015 (CN) 201510050310.9
Jan. 30, 2015 (CN) 201510050419.2

(51) Int. Cl. G01P 15/125; G01P 15/08

(52) U.S. Cl. CPC G01P 15/125; G01P 15/0802

(57) ABSTRACT

The present invention discloses a Z-axis structure of an accelerometer and a manufacturing method of the Z-axis structure. The Z-axis structure comprises a substrate, fixed electrodes and a mass block, wherein first anchor is arranged on a surface of the substrate; the fixed electrode is connected onto the corresponding first anchor at an end thereof; the fixed electrode is suspended above the substrate via the first anchor; an intermediate anchor is also arranged on the surface of the substrate; and the mass block is suspended above the fixed electrode via the intermediate anchor. In the Z-axis structure of the present invention, the fixed electrode is connected to the substrate by the first anchor, so that there is certain gap between the fixed electrode and the substrate. Because of the gap, the path for deformation to transmitting from the substrate to the fixed electrode is cut off, such that contact area between the fixed electrode and the substrate is reduced, effectively preventing the deformation of the substrate caused by changes of external stress and temperature from transmitting to the fixed electrode, and greatly reducing zero point offset of a Z-axis structure.

### FIELD OF THE INVENTION

The present invention relates to the field of micro-electromechanical systems (MEMS), and more particularly, relates to a micro-electromechanical accelerometer, in particular to a Z-axis structure of an accelerometer. The present invention further relates to a manufacturing method of the Z-axis structure.

### BACKGROUND OF THE INVENTION

Conventional Z-axis accelerometers are flat-plate-capacitive accelerometers, and the movement mode of mass blocks is similar to that of a seesaw structure. Referring to FIG. 1, there are two metallic fixed electrodes 2 on a substrate 1 below a mass block 3, and the two fixed electrodes 2 are attached onto the surface of the substrate 1. The capacitor (C1 or C2) is formed between each fixed electrode 2 and the corresponding mass block 3, wherein the mass block 3 is supported above the substrate by an anchor 4.

This Z-axis structure is relatively sensitive to deformation caused by changes of external stress and temperature. The deformation caused by the changes of the external stress and the temperature acts on the substrate 1 first, and then transfers to the fixed electrode 2. As the fixed electrode 2 is attached onto the substrate 1, deformation of the substrate 1 is directly to be reflected on the fixed electrode 2. Under normal circumstances, the deformations of the two fixed electrodes 2 are unequal, which results the capacitances of the two fixed electrodes 2 are unequal in the absence of an accelerometer input, and finally outputs deviation signal, which forms the zero point offset of an accelerometer reflected on chip. From the view of the designer, the smaller the zero point offset is, the better the effect of an accelerometer is. However, because of the structure of an accelerometer, the zero point offset caused by the changes of the external stress and the temperature is unavoidable.

### SUMMARY OF THE INVENTION

One object of the present invention is to provide a new technical solution of Z-axis structure of an accelerometer.

According to the first aspect of the present invention, there provides a Z-axis structure of an accelerometer. The Z-axis structure comprises a substrate, a fixed electrode and a mass block, wherein a first anchor is arranged on a surface of the substrate; the fixed electrode is connected onto the corresponding first anchor at an end thereof; the fixed electrode is suspended above the substrate via the first anchor; an intermediate anchor is also arranged on the surface of the substrate; and the mass block is suspended above the fixed electrode via the intermediate anchor.

Preferably, the fixed electrode is integrally formed with the first anchor.

Preferably, the first anchor is adjacent to the intermediate anchor.

Preferably, the fixed electrode is made of monocrystalline silicon material or polycrystalline silicon material.

Preferably, a plurality of through holes is formed on the mass block and the fixed electrode respectively.

Preferably, a lower surface of the fixed electrode is further provided with a reinforcing structure.

The present invention further provides a manufacturing method of a Z-axis structure, comprising the following steps: (a), etching to form two first anchors and a first intermediate anchor located therebetween on a lower surface of a fixed electrode; (b), press-fitting fixed electrode onto a substrate by the first anchor and the first intermediate anchor; (c), etching an upper surface of the fixed electrode, except for a location of the first intermediate anchor, to make the first intermediate anchor to be higher than other locations on the upper surface of the fixed electrode; (d), etching away locations between the first anchor and the first intermediate anchor on the fixed electrode to separate the first intermediate anchor from the fixed electrode, and etching the fixed electrode into a predetermined size; (e), press-fitting the mass block at an upper end of the first intermediate anchor; and (f), etching on the mass block to form a second intermediate anchor located on the first intermediate anchor as well as a connecting beam for connecting the mass block and the second intermediate anchor.

The present invention further provides a manufacturing method of a Z-axis structure, comprising the following steps: (a), depositing a first sacrificial layer on a substrate, and etching to form regions for a first anchor and a first intermediate anchor on the first sacrificial layer; (b), depositing fixed electrode layer on the first sacrificial layer and the regions for the first anchor and first intermediate anchor; (c), etching on the fixed electrode layer to form a pattern of fixed electrode connected with the first anchor and a pattern of the first intermediate anchor, and etching to form a plurality of through holes; (d), depositing a second sacrificial layer on the fixed electrode and a region for the first intermediate anchor; (e), etching away the second sacrificial layer located right on the first intermediate anchor; (f), depositing a mass block layer on the second sacrificial layer and etching on the mass block layer to form patterns of the mass block and the second intermediate anchor, wherein the second intermediate anchor is located right on the first intermediate anchor; and etching on the mass block to form a plurality of through holes; and (g), removing the first sacrificial layer and the second sacrificial layer to form a Z-axis structure.

Preferably, the manufacturing method comprises, between steps (b) and (c), a step of flattening the fixed electrode layer to a predetermined thickness.

Preferably, the step (f) further comprises flattening the mass block layer to a predetermined thickness before etching on the mass block layer to form the patterns of the mass block and the second intermediate anchor.

According to a Z-axis structure of the present invention, a fixed electrode is connected to a substrate by a first anchor, in order to form certain gap between the fixed electrode and the substrate. Because of the gap, the path for deformation to transmit from the substrate to the fixed electrode is cut off, such that the contact area between the fixed electrode and the substrate is reduced, effectively preventing the deformation of the substrate caused by changes of external stress and temperature from transmitting to the fixed electrode, and greatly reducing zero point offset of a Z-axis structure.

The inventor of the present invention has found that in the prior art, the deformation of a substrate caused by the changes of the external stress and the temperature can be transmitted to a fixed electrode, thus leading to a fixed electrode to deform, and resulting in the difference values between the two capacitors. Therefore, the technical mission to be achieved or the technical problem to be solved in the present invention is unintentional or unanticipated to those skilled in the art, and thus the present invention refers to a novel technical solution.

Further features of the present invention and advantages thereof will become apparent from the following detailed description of exemplary embodiments according to the present invention with reference to the attached drawings.

### BRIEF DESCRIPTION OF THE DRAWINGS

The accompanying drawings, which are incorporated in and constitute a part of the specification, illustrate embodiments of the invention and, together with the description thereof, serve to explain the principles of the present invention.

FIG. 1 is a schematic diagram of a conventional Z-axis structure.

FIG. 2 is a schematic diagram of the Z-axis structure in the present invention.

FIGS. 3-9 show a schematic flow chart of the manufacturing method of the Z-axis structure shown in FIG. 2.

FIG. 10 is a schematically structural view of the Z-axis structure according to another embodiment of the present invention.

FIGS. 11-18 show a schematic flow chart of the manufacturing method of the Z-axis structure shown in FIG. 10.

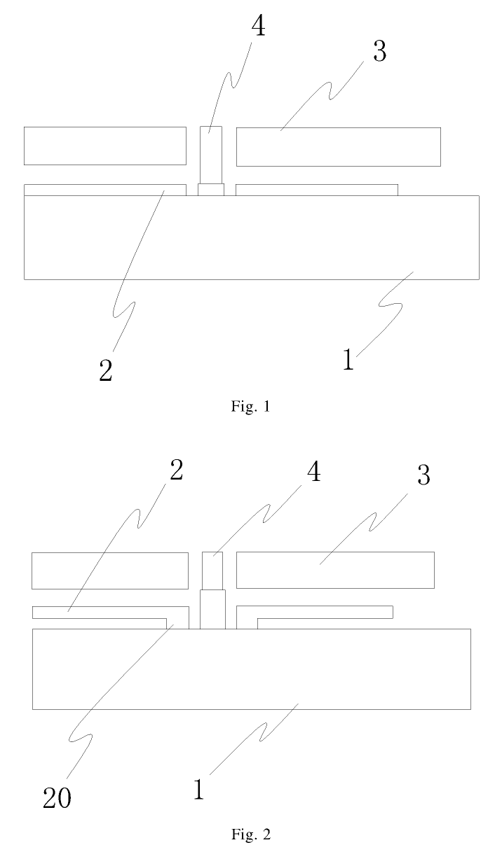

### DETAILED DESCRIPTION OF THE EMBODIMENTS

Various exemplary embodiments of the present invention will now be described in detail with reference to the drawings. It should be noted that the relative arrangement of the components and steps, the numerical expressions, and numerical values set forth in these embodiments do not limit the scope of the present invention unless it is specifically stated otherwise.

The following description of at least one exemplary embodiment is merely illustrative in nature and is in no way intended to limit the invention, its application, or uses.

Techniques, methods and apparatus as known by one of ordinary skill in the relevant art may not be discussed in detail but are intended to be part of the specification where appropriate.

In all of the examples illustrated and discussed herein, any specific values should be interpreted to be illustrative only and non-limiting. Thus, other examples of the exemplary embodiments could have different values.

Notice that similar reference numerals and letters refer to similar items in the following figures, and thus once an item is defined in one figure, it is possible that it need not be further discussed in the accompanying drawings.

In an accelerometer adopting a conventional structure, its X-axis and Y-axis directions utilize the mode of translation, while its Z-axis direction utilizes the mode of seesaw-type deflection. Compared with the structure of conventional Z-axis accelerometer, the present invention provides a Z-axis structure in an accelerometer, which can be configured to detect Z-axis acceleration signal in the vertical direction.

### Embodiment I

Referring to FIG. 2, the present invention provides a Z-axis structure of an accelerometer. The Z-axis structure comprises a substrate 1, a mass block 3 and two fixed electrodes 2, wherein two first anchors 20 are arranged on a surface of the substrate 1 and configured to connect the two fixed electrodes 2, respectively; the fixed electrode 2 is connected onto the corresponding first anchor 20 at an end thereof; the fixed electrode 2 and the corresponding first anchor 20 can be integrally formed and are L-shaped; and the fixed electrode 2 is located in the horizontal direction, while the first anchor 20 is located in the vertical direction. The fixed electrode 2 is approximately parallel to the substrate 1. Due to the arrangement of the first anchor 20, there is a certain gap between each fixed electrode 2 and the substrate 1. That is, the fixed electrode 2 is suspended above the substrate 1 via the first anchor 20. The fixed electrode 2 can be fixed by the corresponding first anchor 20, and of course, can be fixed by a plurality of anchor.

An intermediate anchor 4 is arranged between the two first anchors 20, and is fixed onto the substrate 1. The mass block 3 is suspended above the fixed electrode 2 via the intermediate anchor 4. For example, the mass block 3 is connected with the intermediate anchor 4 by an elastic beam, so that the mass block 3 is elastically supported above the substrate 1 and the fixed electrode 2. Of course, there is certain gap between the mass block 3 and the fixed electrode 2, so that the detection capacitor is formed between each fixed electrode 2 and the mass block 3 respectively. This is well known to those skilled in the art, and the description is omitted herein.

In the Z-axis structure of the present invention, the fixed electrode 2 is connected to the substrate 1 by the first anchor 20, in order to form certain gap between the fixed electrode 2 and the substrate 1. Because of the gap, the path for deformation to transmit from the substrate 1 to the fixed electrode 2 is cut off, such that contact area between the fixed electrode 2 and the substrate 1 is reduced, effectively preventing the deformation of the substrate caused by changes of external stress and temperature from transmitting to the fixed electrode, and greatly reducing zero point offset of the Z-axis structure.

In the Z-axis structure of the present invention, the first anchor 20 is adjacent to the intermediate anchor 4. The two first anchors 20 are symmetrically distributed at two sides of the intermediate anchor 4. Without affecting the acceleration performance, in order to greatly reduce capacitance output deviation caused by changes of external stress and temperature, the first anchor 20 is as close as possible to the intermediate anchor 4.

Further, the fixed electrode 2 is made of monocrystalline silicon material, in order to improve the resistance to deformation of the fixed electrode 2. Preferably, the thickness of the fixed electrode 2 is 10 microns or above. Furthermore, it may be 20-30 microns. In order to further ensure the strength of the fixed electrode 2, a reinforcing structure such as a mesh reinforcing rib structure can be arranged on a lower surface of each fixed electrode 2.

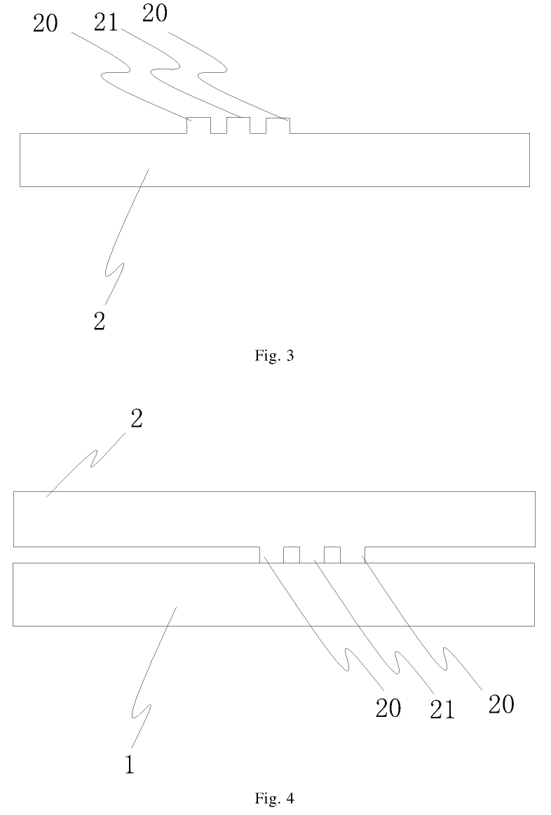

Referring to FIGS. 3-9, the present invention further provides a manufacturing method of a Z-axis structure, and the method comprises the steps as follows.

(a) Two first anchors 20 and a first intermediate anchor 21 located therebetween are etched to form on a lower surface of fixed electrode 2, wherein the two first anchors 20 are symmetrically distributed at the two sides of the first intermediate anchor 21, and can be as close as possible to the intermediate anchor 21. Referring to FIG. 3, there is gap among the three anchors.

(b) The fixed electrode 2 is press-fitted onto the substrate 1 by the first anchor 20 and the first intermediate anchor 21. That is, free ends of the first anchor 20 and the first intermediate anchor 21 are press-fitted on the substrate 1. Referring to FIG. 4, the press-fitting manner therebetween can be bonding manner, such as silicon-silicon bonding, silicon-silica bonding or alloy bonding.

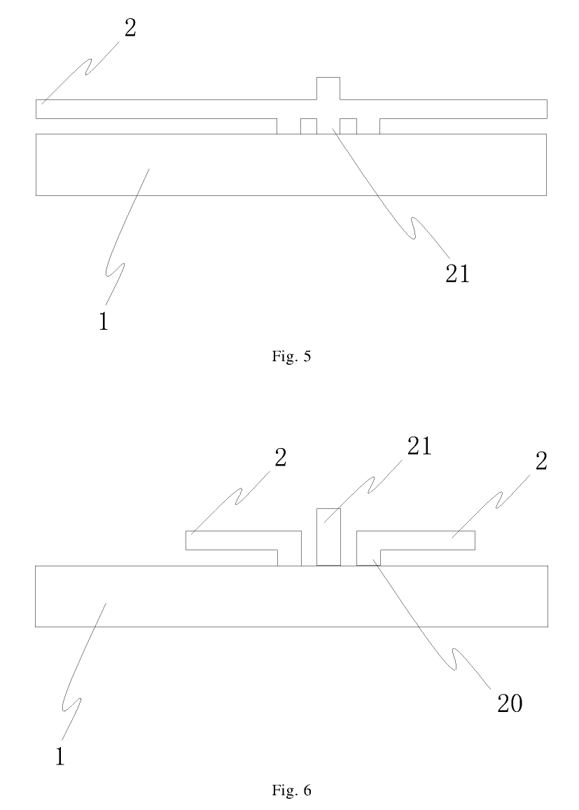

(c) An upper surface of the fixed electrode 2, except for the location of the first intermediate anchor 21, is etched, so that the first intermediate anchor 21 is higher than other locations on the upper surface of the fixed electrode 2. Referring to FIG. 5, it can be also understood that an upper end of the first intermediate anchor 21 is etched out from the upper surface of the fixed electrode 2, so that the upper end of the first intermediate anchor 21 is higher than the upper surface of the fixed electrode 2.

(d) The locations between the first anchor 20 and the first intermediate anchor 21 on the fixed electrode 2 are etched away, so as to separate the first intermediate anchor 21 from the fixed electrode 2 and the first anchor 20; and referring to FIG. 6, the fixed electrode 2 is etched into a predetermined size.

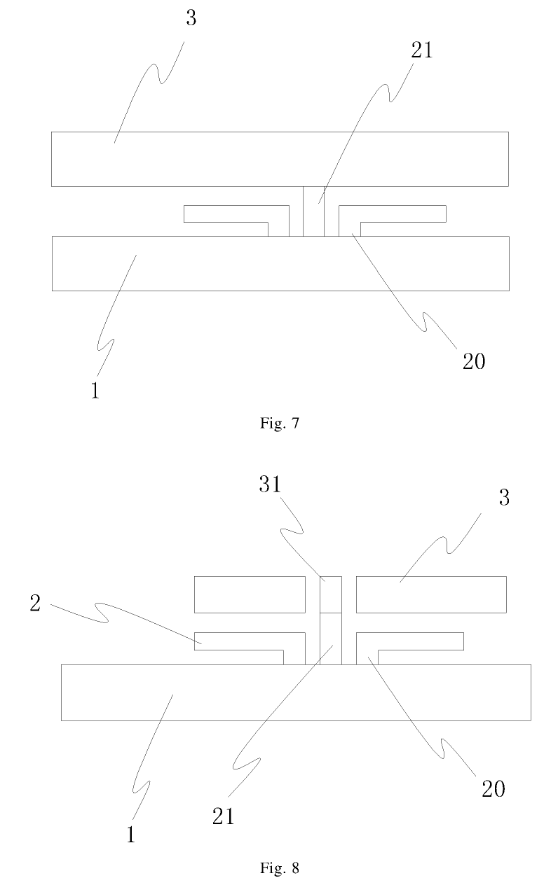

(e) The upper end of the first intermediate anchor 21 is press-fitted with the mass block 3. That is, the mass block 3 is press-fitted at the upper end of the first intermediate point 21. Based on the above-mentioned principle, the press-fitting manner therebetween can be bonding manner, such as silicon-silicon bonding, silicon-silica bonding or alloy bonding. Referring to FIG. 7, as the first intermediate anchor 21 is higher than the surface of the fixed electrode 2, there is certain gap between the mass block 3 press-fitted on the first intermediate anchor 21 and fixed electrode 2.

(f) A second intermediate anchor 31 located on the first intermediate anchor 21 as well as a connecting beam (not shown in the drawing) for connecting the mass block 3 and the second intermediate anchor 31 are etched to form on the mass block 3, and the mass block 3 is etched into a predetermined size. That is, the above-mentioned intermediate anchor 4 of the present invention includes the first intermediate anchor 21 and the second intermediate anchor 31 which are press-fitted together, wherein the first intermediate anchor 21 is etched out from the fixed electrode 2, and the second intermediate anchor 31 is etched out from the mass block 3. Referring to FIG. 8, the first intermediate anchor 21 and the second intermediate anchor 31 that are press-fitted together to constitute the intermediate anchor 4, which is configured to support the mass block 3 above the substrate 1 and the fixed electrode 2. The second intermediate anchor 31 and the connecting beam are etched out from the whole mass block 3; in order to support the mass block 3 elastically above the substrate 1.

Preferably, a step of thinning the fixed electrode 2 by etching is further included between step (b) and step (c), and a step of thinning the mass block 3 by etching is further included between step (e) and step (f), so that the damage caused by etching the fixed electrode 2 and the mass block 3 without support structure is avoided.

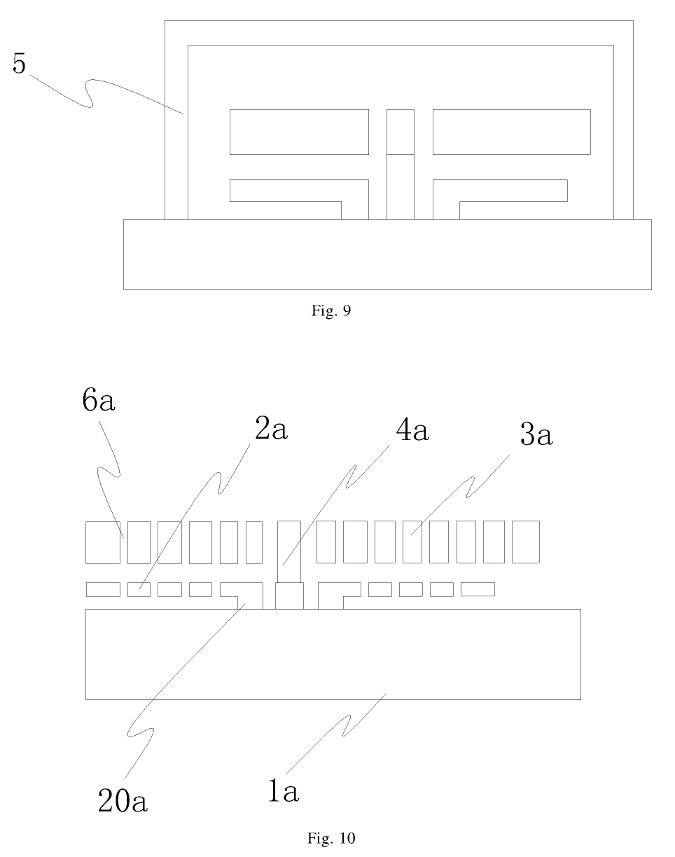

Referring to FIG. 9, of course, the manufacturing method provided in the present invention further includes the step of press-fitting a housing 5 on the substrate 1, so as to encapsulate all components in the housing 5.

### Embodiment II

Referring to FIG. 10, the present invention provides a Z-axis structure of an accelerometer. The Z-axis structure comprises a substrate 1a, a mass block 3a and two fixed electrodes 2a, wherein two first anchors 20a are arranged on a surface of the substrate 1a and configured to connect the corresponding fixed electrode 2a, respectively; the fixed electrode 2a is connected onto the corresponding first anchor 20a at an end thereof; the fixed electrode 2a and the corresponding first anchor 20a can be integrally formed and are L-shaped; the fixed electrode 2a is located in the horizontal direction, while the first anchor 20a is located in the vertical direction. The fixed electrode 2a is approximately parallel to the substrate 1a. Due to the arrangement of the first anchor 20a, there is certain gap between each fixed electrode 2a and the substrate 1a. That is, the fixed electrode 2a is suspended above the substrate 1a via the first anchor 20a. The fixed electrode 2a can be fixed by the corresponding first anchor 20a, and of course, can be fixed by a plurality of anchor.

An intermediate anchor 4a is arranged between the two first anchors 20a, and is fixed onto a surface of the substrate 1a. The mass block 3a is electrically suspended above the fixed electrode 2a via the intermediate anchor 4a. For example, the mass block 3a is connected with the intermediate anchor 4a by an elastic beam, so that the mass block 3a is elastically supported above the substrate 1a and the fixed electrode 2a. Of course, there is certain gap between the mass block 3a and the fixed electrode 2a, so that the detection capacitor is formed between each fixed electrode 2a and the mass block 3a respectively. This is well known to those skilled in the art, and the description is omitted herein.

A plurality of through holes 6a is formed on the mass block 3a and the fixed electrode 2a, so as to release the structure of the fixed electrode and the movable mass block easily.

In the Z-axis structure of the present invention, the fixed electrode 2a is connected with the substrate 1a by the first anchor 20a, in order to form certain gap between the fixed electrode 2a and the substrate 1a. Because of the gap, the path for deformation to transmit from the substrate 1a to the fixed electrode 2a is cut off, such that contact area between the fixed electrode 2a and the substrate 1a is reduced, effectively preventing the deformation of the substrate caused by changes of external stress and temperature from transmitting to the fixed electrode, and greatly reducing zero point offset of the Z-axis structure.

In the Z-axis structure of the present invention, the first anchor 20a is adjacent to the intermediate anchor 4a. The two first anchors 20a are symmetrically distributed at two sides of the intermediate anchor 4a. Without affecting the acceleration performance, in order to greatly reduce capacitance difference caused by changes of external stress and temperature, the first anchor 20a is as close as possible to the intermediate anchor 4a.

Further, the fixed electrode 2a is made of monocrystalline silicon material, in order to improve the resistance to deformation of the fixed electrode 2a. Preferably, the thickness of the fixed electrode 2a is 5 microns or above. Of course, if the capacity for processing can be achieved, the thickness of the fixed electrode 2a can be less than 5 microns. In order to further ensure the strength of the fixed electrode 2a, a reinforcing structure such as a mesh reinforcing rib structure can be arranged on a lower surface of each fixed electrode 2a.

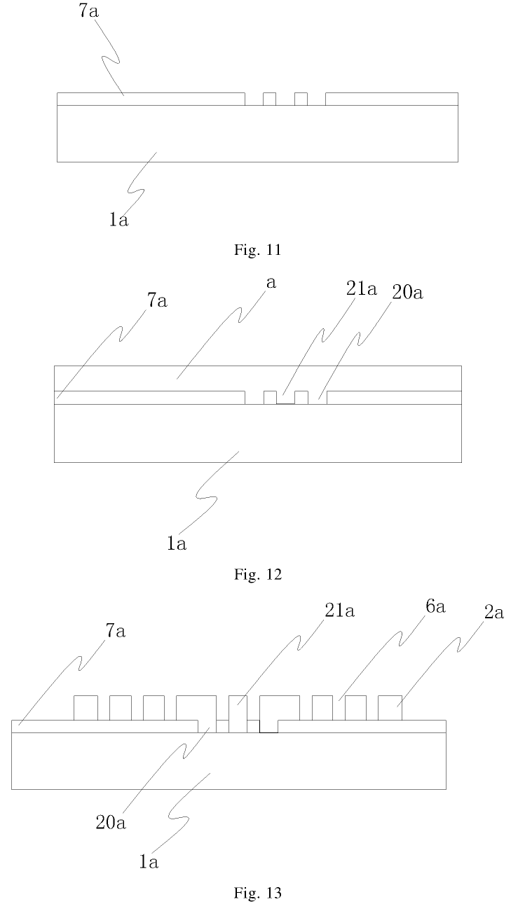

Referring to FIGS. 11-18, the present invention further provides a manufacturing method of a Z-axis structure, and the method comprises the steps as follows.

(a) A first sacrificial layer 7a is deposited on a substrate 1a, and may be made of silicon oxide material, and the regions for a first anchor and a first intermediate anchor are etched to form on the first sacrificial layer 7a, in particular, which is determined based on shapes of the first anchor and the first intermediate anchor. Referring to FIG. 11, for example, if it is required that the two first anchors are symmetrically distributed at two sides of the first intermediate anchor, a corresponding etching region should be formed on the first sacrificial layer 7a.

(b) A fixed electrode layer a is deposited on the first sacrificial layer 7a and the first anchor and first intermediate anchor. Referring to FIG. 12, the fixed electrode layer a includes fixed electrode located right on the first sacrificial layer 7a, as well as a first anchor 20a and a first intermediate anchor 21a located in the regions for first anchor and first intermediate anchor. The first sacrificial layer 7a in this region is etched away, so that the first anchor 20a and the first intermediate anchor 21a are directly deposited on the substrate 1a, realizing to connect the first anchor 20a and the first intermediate anchor 21a to the substrate 1a. The fixed electrode layer a may be made of polycrystalline silicon material, improving the strength of the fixed electrode layer.

Considering the influence of the region for the first anchor and first intermediate anchor, in order to finally obtain the fixed electrode layer with a predetermined thickness, the deposited thickness of the fixed electrode layer is larger than the predetermined thickness, and then the flattening treatment is performed. That is, the deposited fixed electrode layer is thinned by etching, and then step (c) is carried out.

(c) Patterns of the fixed electrode 2a and the first intermediate anchor 21a are formed by etching the fixed electrode layer a, and a plurality of through holes 6a is etched on the fixed electrode 2a. That is, referring to FIG. 13, the fixed electrode 2a is separated from the first intermediate anchor 21a, while the fixed electrode 2a is connected onto the substrate by the first anchor 20a.

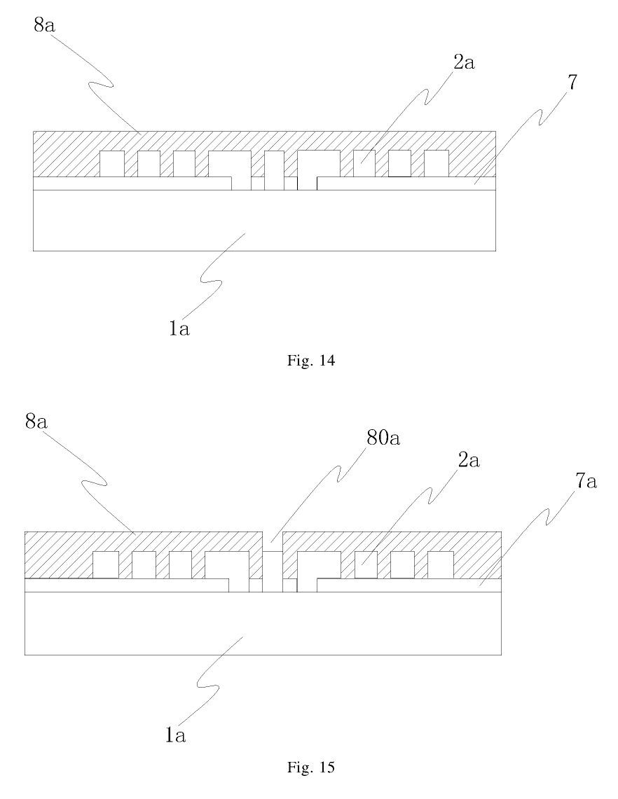

(d) A second sacrificial layer 8a is deposited on the fixed electrodes 2a and the first intermediate anchor 21a. Referring to FIG. 14, the second sacrificial layer 8a is not only located above the fixed electrodes 2a and the first intermediate anchor 21a, but also deposited in the through holes 6a and gap between the first intermediate anchor 21a and the fixed electrodes 2a. Similarly, the deposited thickness of the second sacrificial layer 8a is larger than a predetermined thickness, and then the flattening treatment is performed. That is, the second sacrificial layer 8a is thinned by etching, and then step (e) is carried out.

(e) Referring to FIG. 15, the second sacrificial layer 8a located right on the first intermediate anchor 21a is etched away to form a groove 80a.

(f) A mass block layer is deposited on the second sacrificial layer 8a. Here, the mass block layer is deposited not only on the second sacrificial layer 8a, but also in the groove 80a, and is connected to the first intermediate anchor 21a. Similarly, considering the influence of the groove 80a, in order to finally obtain the mass block layer with a predetermined thickness, the deposited thickness of the mass block layer is larger than the predetermined thickness, and then the flattening treatment is performed. That is, the deposited mass block layer is thinned by etching, and then the following etching process is carried out.

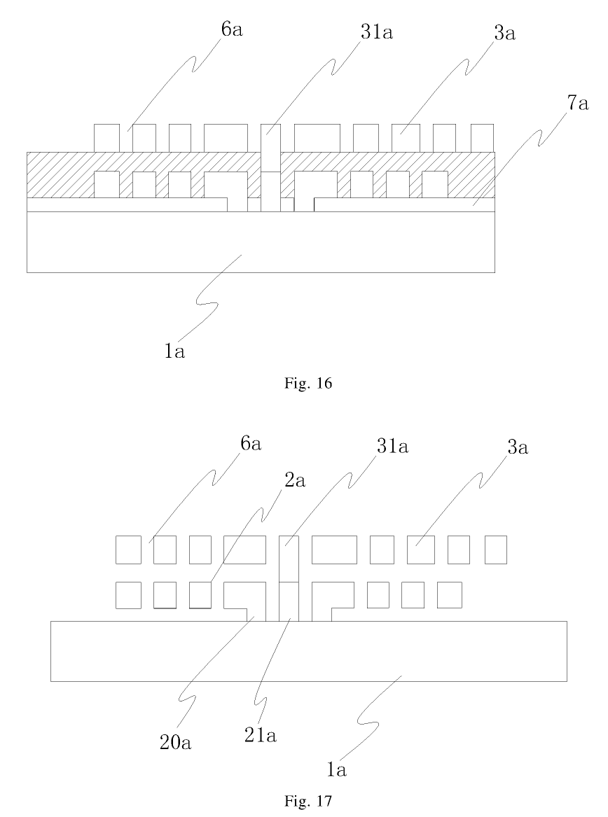

The patterns of a mass block 3a and a second intermediate anchor 31a are formed by etching the mass block layer. Referring to FIG. 16, the second intermediate anchor 31a is located right on the first intermediate anchor 21a and a plurality of through holes 6a is formed by etching the mass block 3a. That is, the mass block 3a and the second intermediate anchor 31a are etched out from the mass block layer, so that the mass block 3a and the second intermediate anchor 31a are connected together only through an elastic beam finally. That is, the intermediate anchor 4a of the present invention includes the first intermediate anchor 21a and the second intermediate anchor 31a which are deposited together, wherein the first intermediate anchor 21a is etched out from the fixed electrode layer, and the second intermediate anchor 31a is etched out from the mass block layer. The first intermediate anchor 21a and the second intermediate anchor 31a that are deposited together to constitute the intermediate anchor 4a, which is configured to support the mass block 3a above the substrate 1a and the fixed electrode 2a.

(g) Referring to FIG. 17, the first sacrificial layer 7a and the second sacrificial layer 8a are removed to form the Z-axis structure of the present invention. The first sacrificial layer and the second sacrificial layer 8a can be corroded off via an HF solution or gaseous HF. This is well known to those skilled in the art, and the description is omitted herein. Through the through holes in the mass block 3a and the fixed electrode 2a, the corroding speed of the first sacrificial layer 7a and the second sacrificial layer 8a can be accelerated, so as to quickly release the mass block 3a and the fixed electrode 2a.

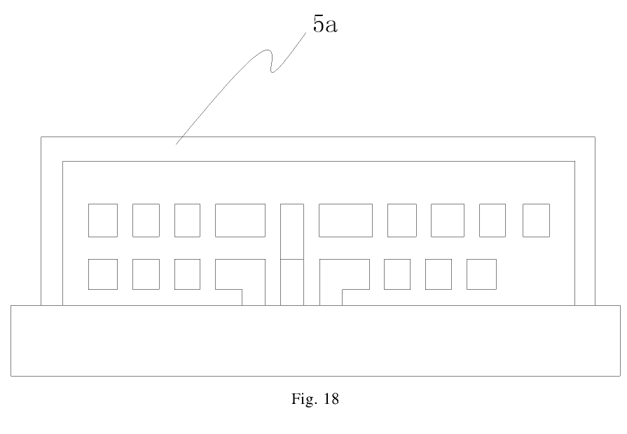

Referring to FIG. 18, of course, the manufacturing method provided by the present invention further includes the step of press-fitting a housing 5a on the substrate 1a, so as to encapsulate all components in the housing 5a.

The first sacrificial layer 7a in step (a) and the second sacrificial layer 8a in step (d) are not limited to the silicon oxide material, and also can be made of an organic material such as polyimide (PI).

In the manufacturing method of the present invention, in the deposition process of the fixed electrode layer, internal stress can be increased by adjusting a process parameter, while in the deposition process of the mass block layer, internal stress of a film can be reduced by adjusting the process parameter.

Although some specific embodiments of the present invention have been demonstrated in detail with examples, it should be understood by a person skilled in the art that the above examples are only intended to be illustrative but not to limit the scope of the present invention. It should be understood by those skilled in the art that the above embodiments could be modified without departing from the scope and spirit of the present invention. The scope of the present invention is defined by the appended claims.

1. A Z-axis structure of an accelerometer, the Z-axis structure comprising: a substrate, a fixed electrode and a mass block, wherein a first anchor is arranged on a surface of the substrate; the fixed electrode is connected onto the corresponding first anchor at an end thereof; the fixed electrode, is suspended above the substrate via the first anchor; an intermediate anchor is also arranged on the surface of the substrate; and the mass block is suspended above the fixed electrode via the intermediate anchor.

2. The Z-axis structure according to claim 1, wherein the fixed electrode is integrally formed with the first anchor.

3. The Z-axis structure according to claim 1, wherein the first anchor is adjacent to the intermediate anchor.

4. The Z-axis structure according to claim 1, wherein the fixed electrode is made of monocrystalline silicon or polycrystalline silicon material.

5. The Z-axis structure according to claim 1, wherein a plurality of through holes is formed on the mass block and the fixed electrode respectively.

6. The Z-axis structure according to claim 1, wherein a lower surface of the fixed electrode is further provided with a reinforcing structure.

7. A manufacturing method of a Z-axis structure, comprising the following steps:
(a), etching to form two first anchors and a first intermediate anchor located therebetween on a lower surface of a fixed electrode;
(b), press-fitting the fixed electrode onto a substrate by the first anchor and the first intermediate anchor;
(c), etching an upper surface of the fixed electrode, except for a location of the first intermediate anchor, to make the first intermediate anchor to be higher than other locations on the upper surface of the fixed electrode;
(d), etching away locations between the first anchor and the first intermediate anchor on the fixed electrode to separate the first intermediate anchor from the fixed electrode, and etching the fixed electrode into a predetermined size;
(e), press-fitting a mass block at an upper end of the first intermediate anchor; and
(f), etching on the mass block to form a second intermediate anchor located on the first intermediate anchor as well as a connecting beam for connecting the mass block and the second intermediate anchor.

8. A manufacturing method of a Z-axis structure, comprising the following steps:
(a), depositing a first sacrificial layer on a substrate, and etching to form regions for a first anchor and a first intermediate anchor on the first sacrificial layer;
(b), depositing a fixed electrode layer on the first sacrificial layer and the regions for the first anchor and the first intermediate anchor;
(c), etching on the fixed electrode layer to form a pattern of the fixed electrode connected with the first anchor and a pattern of the first intermediate anchor, and etching on the fixed electrode to form a plurality of through holes;
(d), depositing a second sacrificial layer on the fixed electrode and a region for the first intermediate anchor;
(e), etching away a part of the second sacrificial layer located right on the first intermediate anchor;
(f), depositing a mass block layer on the second sacrificial layer and etching on the mass block layer to form patterns of a mass block and a second intermediate anchor, wherein the second intermediate anchor is located right on the first intermediate anchor; and etching on the mass block to form a plurality of through holes; and
(g), removing the first sacrificial layer and the second sacrificial layer to form a Z-axis structure.

9. The manufacturing method according to claim 8, further comprising, between the step (b) and the step (c), a step of flattening the fixed electrode layer to a predetermined thickness.

10. The manufacturing method according to claim 8, wherein the step (f) further comprises flattening the mass block layer to a predetermined thickness before etching on the mass block layer to form patterns of the mass block and the second intermediate anchor.
